(19) United States
(12) Patent Application Publication
(10) Pub. No.: US 2016/0364261 A1
(43) Pub. Date: Dec. 15, 2016

(54) APPARATUS AND METHOD FOR PROVIDING ADAPTIVE VIRTUAL DESKTOP OPERATING SYSTEM SERVICE

(71) Applicant: ELECTRONICS AND TELECOMMUNICATIONS RESEARCH INSTITUTE, Daejeon (KR)

(72) Inventors: Byeong Thaek OH, Daejeon (KR); Sun Wook KIM, Hwaseong (KR); Soo Cheol OH, Daejeon (KR); Dae Won KIM, Daejeon (KR); Seong Woon KIM, Gyeryong (KR); Hag Young KIM, Daejeon (KR); Jong Bae MOON, Daejeon (KR); Jung hyun CHO, Daejeon (KR); Ji Hyeok CHOI, Gunpo (KR)

(21) Appl. No.: 15/183,656

(22) Filed: Jun. 15, 2016

(30) Foreign Application Priority Data
Jun. 15, 2015 (KR) 10-2015-0084215

(51) Int. Cl. G06F 9/455; G06F 9/44; H04L 29/08

(52) U.S. Cl. CPC G06F 9/45558; H04L 67/08; G06F 9/4443; G06F 2009/45595

(57) ABSTRACT

An apparatus and method for providing an adaptive virtual desktop operating system (OS) service is provided. The method for providing an adaptive virtual desktop OS service in a virtual OS service platform server, which provides a virtual OS service platform service suitable for a terminal connected through a network, includes collecting and analyzing environmental information including at least one among hardware specification information, computing resource information, and network traffic information of the terminal, computing resource information of a guest OS operated in a virtual machine generated by the virtual OS service platform server; determining an environmental setting factor for structuring a user interface (UI) suitable for the terminal with respect to the virtual machine based on the analyzed result; and adaptively generating or changing a UI of the virtual OS service platform provided to the terminal based on the determined environmental setting factor.

### CROSS-REFERENCE TO RELATED APPLICATION

This application claims priority to and the benefit of Korean Patent Application No. 10-2015-0084215, filed on Jun. 15, 2015, the disclosure of which is incorporated herein by reference in its entirety.

### BACKGROUND

### 1. Field of the Invention

The present invention relates to a virtual operating system (OS) platform application service using server virtualization technology, and more particularly, to adaptive virtualization service technology allowing a virtual OS system service to be smoothly used according to an environment of a terminal when providing a virtual desktop service.

### 2. Discussion of Related Art

Virtual desktop infrastructure (VDI) technology uses virtualization technology, virtualizes an operating system (OS) and an application program, and provides a service in the center, and a user uses a virtualized desktop environment by using an Internet, a wireless network, a local area network (LAN), etc. The user connects to the virtual desktop environment using a traditional personal computer (PC) or a thin client. Generally, the OS and the application program in which the user uses as the virtual desktop environment are executed in a server of the center. Further, working data is not directly stored in a terminal of the user, and is stored in the server managed in the center.

According to a conventional art, when executing an application program using an OS for a mobile terminal in a terminal having a low hardware specification such as a tablet PC, a smart phone, or a smart watch, use of various application programs is limited due to limitations of performance of a central processing unit (CPU), a storage space, a corresponding OS, etc.

Further, even when the user uses an OS for a conventional desktop by connecting to a virtual desktop using a client program for connecting to the VDI using the terminal having the low hardware specification, it is not easy to use an application program supporting a user interface (UI) for the conventional desktop having a high resolution.

Meanwhile, various terminals such as smart phones and smart watches are being developed in order to access needed information even while moving. However, although the hardware specification of the mobile terminal such as the smart phone or the smart watch, etc. is continuously improving, it is not easy to selectively execute various OSs and application programs due to the limitation of the hardware specification.

In some cases, it is necessary for the user to perform computing work or confirm a document by executing an application program for desktop even while moving, but it is difficult to use applications other than applications for the smart phone or the smart watch.

### SUMMARY OF THE INVENTION

The present invention is directed to an apparatus and method for supporting an adaptive operating system (OS) and an application program which allows an application having a high specification to be executed even when a hardware specification of a terminal is not good, and adaptively changes a user interface (UI) according to a display environment of the terminal.

The above and other objects, features and advantages of the present invention will become more apparent to those of ordinary skill in the art by describing in detail exemplary embodiments thereof with reference to the accompanying drawings.

According to one aspect of the present invention, there is provided a method for providing an adaptive virtual desktop operating system (OS) service in a virtual OS service platform server providing a virtual OS service platform service suitable for a terminal connected through a network, the method including collecting and analyzing environmental information including at least one among hardware specification information, computing resource information, and network traffic information of the terminal, and computing resource information of a guest OS operated in a virtual machine generated by the virtual OS service platform server; determining an environmental setting factor for structuring a user interface (UI) suitable for the terminal with respect to the virtual machine based on the analyzed result; and adaptively generating or changing a UI of the virtual OS service platform provided to the terminal based on the determined environmental setting factor.

The collecting and analyzing of the environmental information may include: receiving at least one among the hardware specification information, the computing resource information, and the network traffic information from the terminal.

The collecting and analyzing of the environmental information, the determining of the environmental setting factor, and the adaptively generating or changing of the UI may comprise performed in the virtualization desktop platform layer included in the virtual OS service platform server.

The collecting and analyzing of the environmental information, and the determining of the environmental setting factor may comprise performed in the virtualization desktop platform layer included in the virtual OS service platform server, wherein the adaptively generating or changing of the UI comprises adaptively generating or changing the UI of a virtual OS, by each of the virtual machine, based on the determined environmental setting factor which transmitted in the virtualization desktop platform layer to any one among the plurality of virtual machines.

The collecting and analyzing of the environmental information may comprises: collecting the environmental information from the terminal through the network; transmitting the collected environmental information to any one among the plurality of virtual machines; and analyzing of the environmental information by the virtual machines receiving the environmental information, wherein the determining of the environmental setting factor comprises determining the environmental setting factor by the virtual machines receiving the environmental information based on the analyzed result.

The determining of the environmental setting factor may include: determining a virtual OS UI setting factor including a screen resolution and a UI method which is able to be provided by the terminal.

The determining of the environmental setting factor may include: determining the environmental setting factor for each guest OS and each terminal virtualized using a database regarding a method of structuring the UI for each virtualized guest OS and each terminal.

The adaptively generating or changing of the UI may include: adaptively changing a screen resolution and a UI provision method of an application program operating in a guest OS and an environment of the guest OS for each terminal.

Further, the method for providing the adaptive virtual desktop OS service may include: when the terminal which is connected to the virtual OS service platform server and receives an adaptive virtual OS service platform service is a mobile terminal, preferentially providing an application program developed for the mobile terminal in a desktop-based OS to the mobile terminal.

According to one aspect of the present invention, there is provided a virtual operating system (OS) service platform server providing a virtual OS service platform service suitable for a terminal connected through a network, including a resource monitoring module configured to collect and analyze environmental information including at least one among hardware specification information and computing resource information of the terminal, computing resource information of a guest OS operated in a virtual machine, and network traffic information of the terminal, through the network; a service traffic analysis module configured to collect and analyze the network traffic information of the terminal; an environmental setting factor determination module configured to determine an environmental setting factor for structuring a user interface (UI) suitable for the terminal with respect to the virtual machine based on the analyzed result in the resource monitoring module and the service traffic analysis module; and a UI control module configured to adaptively generate or change a UI of a virtual OS service platform provided to the terminal based on the determined environmental setting factor.

The environmental setting factor determination module may determine the environmental setting factor for each guest OS and each terminal virtualized using a database regarding a method of structuring the UI for each virtualized guest OS or each terminal.

The communication module may receive at least one among the hardware specification information, the computing resource information, and the network traffic information from the terminal.

Further, the virtual OS service platform server further include a virtualization desktop platform layer, wherein the communication module collect the environmental information of the terminal in the virtualization desktop platform layer, and the control module analyze the environmental information, determine the environmental setting factor based on the analyzed result, and adaptively generate or change the UI of a virtual OS service platform based on the determined environmental setting factor in the virtualization desktop platform layer.

Further, the virtual OS service platform server further include a virtualization desktop platform layer, wherein the communication module collect the environmental information of the terminal in the virtualization desktop platform layer, and the control module analyze the environmental information, determine the environmental setting factor based on the analyzed result, and transmitting the environmental setting factor to any one among the plurality of virtual machines in the virtualization desktop platform layer, wherein the virtual machine adaptively generate or change the UI of a virtual OS service platform based on the determined environmental setting factor.

The communication module may collect the environmental information from the terminal through the network, and transmit the collected environmental information to any one among the plurality of virtual machines, wherein the virtual machines receiving the environmental information analyzing of the environmental information, and determine the environmental setting factor based on the analyzed result.

The UI control module may adaptively change a screen resolution and a UI provision method of an application program operating in a guest OS and an environment of the guest OS for each terminal.

Further, the virtual OS service platform server may further include a guest OS UI control module configured to support an interface so that a user checks a UI environmental setting factor determined for each terminal and changes the UI environmental setting factor.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a diagram illustrating a configuration of a system for providing a cloud computing environment-based adaptive virtual operating system (OS) service according to an embodiment of the present invention;

FIG. 2 is a diagram illustrating a configuration of a terminal of a system for providing a cloud computing environment-based adaptive virtual OS service according to an embodiment of the present invention;

FIG. 3 is a diagram illustrating a configuration of a cloud computing environment-based virtual OS service platform server according to an embodiment of the present invention; and

FIG. 4 is a flowchart for describing a method for providing an adaptive virtual desktop OS service according to an embodiment of the present invention.

### DETAILED DESCRIPTION OF EXEMPLARY EMBODIMENTS

The above and other objects, features and advantages of the present invention will become more apparent with reference to exemplary embodiments which will be described hereinafter with reference to the accompanying drawings. However, the present invention is not limited to exemplary embodiments which will be described hereinafter, and can be implemented as various different types. The exemplary embodiments of the present invention are described below in sufficient detail to enable those of ordinary skill in the art to embody and practice the present invention. The present invention is defined by its claims. Meanwhile, the terminology used herein to describe exemplary embodiments of the invention is not intended to limit the scope of the invention. The articles “a,” “an,” and “the” are singular in that they have a single referent, but the use of the singular form in the present document should not preclude the presence of more than one referent. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Hereinafter, exemplary embodiments of the present invention will be described with reference to accompanying drawings. When adding reference numerals to components of each drawing, the same reference numeral is added even when being shown in another drawing with respect to the same component, and when it is determined that a detailed description of a well-known technology related to the present invention can unnecessarily obscure the subject matter of the present invention, the description will be omitted.

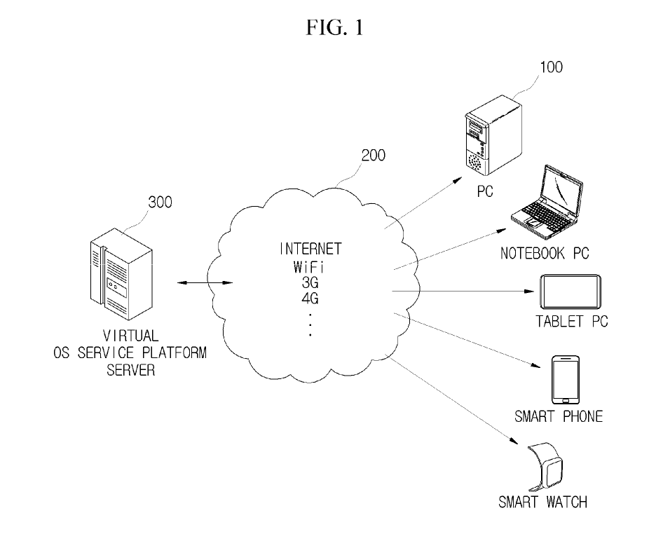

FIG. 1 is a diagram illustrating a configuration of a system for providing a cloud computing environment-based adaptive virtual operating system (OS) service according to an embodiment of the present invention.

As shown in FIG. 1, a system for providing a cloud computing environment-based adaptive virtual OS service according to the embodiment of the present invention may include a terminal 100, a network 200, and a virtual OS service platform server 300.

The terminal 100 may receive a virtual OS service from the virtual OS service platform server 300 through the network 200. Here, the network 200 may include a mobile communication network such as a third generation (3G) network or a fourth generation (4G) network, a wide area network (WAN), a local area network (LAN), etc.

The terminal 100 may be connected to the virtual OS service platform server 300 through any one among the networks 200 described above.

The terminal 100 may be a user terminal capable of using the virtual OS service, and may refer to a PC, a smart phone, a notebook PC, a tablet PC, a smart watch, etc.

The terminal 100 may receive a virtual OS and an application program suitable for an environment of the terminal 100 from the virtual OS service platform server 300 through the network 200.

The virtual OS service platform server 300 may include one or more servers. The virtual OS service platform server 300 may generate a virtual OS service platform by combining a virtual hardware resource of the server and a software image (a user profile, an application, an OS, etc.), and provide the platform to the terminal 100 using a virtual platform transmission protocol.

In this case, information related to a hardware specification, a computing resource, and a network quality of the terminal 100 may be collected from the terminal 100. Additionally, the virtual OS service platform server 300 may generate the virtual OS service platform suitable for the environment of the terminal 100 by analyzing the collected information.

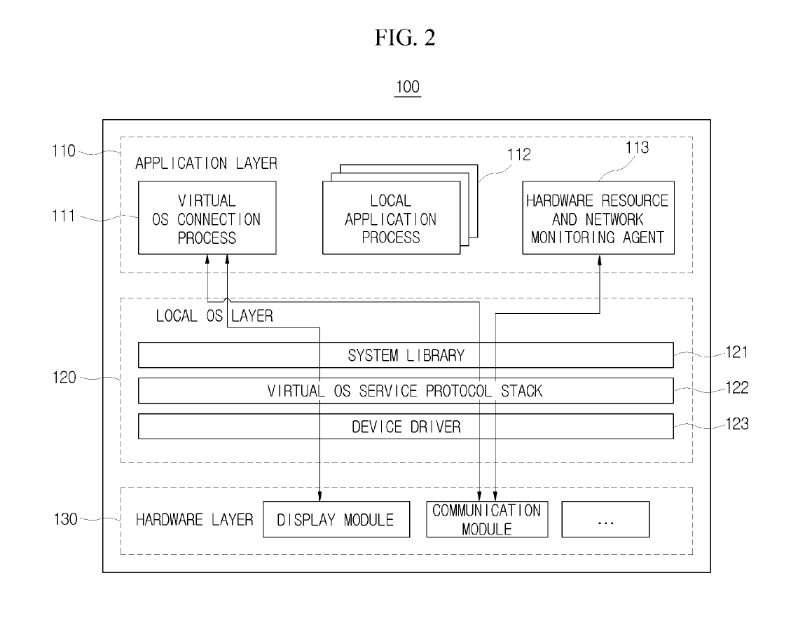

FIG. 2 is a diagram illustrating a configuration of a terminal of a system for providing a cloud computing environment-based adaptive virtual OS service according to an embodiment of the present invention.

Referring to FIG. 2, the terminal 100 according to the embodiment of the present invention may include an application layer 110, a local OS layer 120, and a hardware layer 130, etc.

The application layer 110 may provide various services to a terminal user, or a program performing a data communication service, etc., and include a virtual OS connection process 111, a local application process 112, a hardware resource and a network monitoring agent 113, etc.

The local OS layer 120 may manage execution of various processes included in the application layer 110, and support connection with a plurality of hardware devices included in the hardware layer 130.

The local OS layer 120 may include a system library 121, a virtual OS service protocol stack 122, and a device driver 123, etc.

The local application process 112 may access the device driver 123 such as a video adaptor, a universal serial bus (USB) interface, a serial port interface, an audio adaptor, etc., through the system library 121, and communicate with a hardware device such as a monitor, a communication module, etc.

The virtual OS service protocol stack 122 may collect data from the device driver 123 such as the video adaptor, the USB interface, the serial port interface, the audio adaptor, etc., in order to provide the virtual OS service, and provide the collected data to the hardware resource and the network monitoring agent 113 of the application layer 110.

The terminal 100 shown in FIG. 2 may execute the local application process 112 using the system library 121 of the local OS layer 120. Further, the terminal 100 may receive an adaptive virtual OS service from the virtual OS service platform server 300, which is connected to by performing the virtual OS connection process 111, and the received adaptive virtual OS service may be operated on the virtual OS.

The virtual OS may provide a UI suitable for the environment of the terminal. For this, the hardware resource and the network monitoring agent 113 may monitor and collect a hardware specification and a computing resource of the terminal 100 and network traffic information, and transmit the information to the virtual OS service platform server 300.

Further, the hardware resource and the network monitoring agent 113 may also collect information such as a UI method, etc. which is able to be provided by a corresponding terminal. For example, the information may be information such as a touch screen method, a mouse method, a button arrangement form, etc.

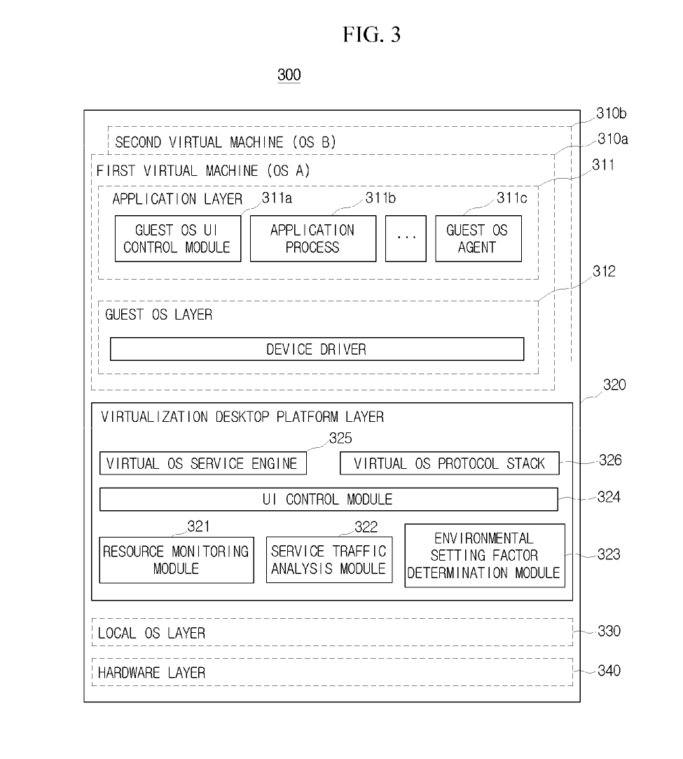

FIG. 3 is a diagram illustrating a configuration of a cloud computing environment-based virtual OS service platform server according to an embodiment of the present invention.

Referring to FIG. 3, the virtual OS service platform server 300 according to the embodiment of the present invention may include a plurality of virtual machines 310a and 310b, a virtualization desktop platform layer 320, a local OS layer 330, and a hardware layer 340, etc.

The plurality of virtual machines 310a and 310b may be operated in the virtual OS service platform server 300. In FIG. 3, an example in which the virtual OS service platform server 300 includes only first and second virtual machines 310a and 310b is illustrated, but this is only for convenience of explanation, and the number of virtual machines included in the virtual OS service platform server 300 is not limited thereto and may be differ according to a kind of the virtual OS.

An application layer 311 in each of the virtual machines 310a and 310b may be operated in an environment of a virtualized guest OS layer 312. The application layer 311 and the guest OS layer 312 may interwork with each other, and generate one virtual OS service platform.

An application process 311b in each of the virtual machines 310a and 310b may provide a UI suitable for each terminal which receives the service for each OS on an application program operating in a virtualized guest OS.

According to the embodiment of the present invention, the UI may be adaptively changed so that the UI of the guest OS provided by being virtualized in each virtual machine and the UI of the application program operating in the guest OS are optimized to the environment of the terminal. Accordingly, the embodiment of the present invention may provide a service provided by various OSs such as an OS for a general desktop, etc. and an application program in the OS to the user even in the environment of the terminal in which a hardware specification is not good. In order to provide the UI optimized for the terminal, environmental information such as the performance and the network condition, etc. of the terminal may be collected and analyzed in the virtualization desktop platform layer 320, and an environmental setting factor for setting the optimized UI may be determined using the analyzed information.

The virtualization desktop platform layer 320 may collect the environmental information such as the computing resource and the network condition, etc. of the device through a communication module (not shown). Further, the virtualization desktop platform layer 320 may analyze the collected environmental information, and determine the environmental setting factor for optimizing the UI of the virtualized guest OS and the UI of the application program operating in the guest OS for each OS or each terminal. The UI may be adaptively changed based on the determined environmental setting factor.

Meanwhile, in the embodiment described above, the environmental information collected in the virtualization desktop platform layer 320 may be analyzed, and the UI may be adaptively changed according to the environmental setting factor based on the analyzed result, but in another embodiment of the present invention, the virtualization desktop platform layer 320 may collect the environmental information such as the computing resource and the network condition, etc. from the terminal through the network, and the collected environmental information may be transmitted to any one among the plurality of virtual machines 310a and 310b.

In this case, operations such as an analysis of the environmental information, a determination of the environmental setting factor, and a change of the UI, etc. may be performed in the virtual machine receiving the environmental information. As such, the operations such as the analysis of the environmental information, the determination of the environmental setting factor, and the change of the UI, etc. may be performed in the virtualization desktop platform layer 320, or in each of the virtual machines. That is, the embodiment of the present invention is not limited to a specific operation performed by a specific object.

Accordingly, each of the virtual machines 310a and 310b and the virtualization desktop platform layer 320 shown in FIG. 3 may be collectively called one control module. The control module may analyze the environmental information collected through the communication module (not shown) described above, determine an environmental setting factor based on the analyzed result, and adaptively restructure the UI based on the determined environmental setting factor.

Hereinafter, for convenience of explanation, an example in which the environmental information of the terminal is collected in the virtualization desktop platform layer 320 through the communication module (not shown), the environmental setting factor is determined by analyzing the collected environmental information, and the UI is adaptively restructured based on the determined environmental setting factor will be described.

The virtualization desktop platform layer 320 may include a resource monitoring module 321, a service traffic analysis module 322, an environmental setting factor determination module 323, a UI control module 324, a virtual OS service engine 325, and a virtual OS protocol stack 326, etc.

The resource monitoring module 321 may collect and analyze computing resource information of the terminal, the virtual OS service platform server, and the guest OS of each virtual machine.

For example, the resource monitoring module 321 may receive a computing resource of the guest OS collected in a guest OS agent 311c through the virtual OS protocol stack 326.

Further, the resource monitoring module 321 may collect and analyze environmental information from the terminal connected to the virtual OS service platform server 300.

In detail, the resource monitoring module 321 may receive environmental information including a screen resolution and every UI method, etc. which are able to be provided by a corresponding terminal for each terminal connected to the virtual OS service platform server 300.

The service traffic analysis module 322 may collect and analyze network traffic information of the terminal through the terminal, the virtual OS service platform server, and the guest OS agent of the virtual OS service platform server.

The resource monitoring module 321 and the service traffic analysis module 322 may interwork with the hardware resource and the network monitoring agent 113 of the terminal 100, and collect the environmental information including computing resource information and network traffic information, etc. of the terminal.

The environmental setting factor determination module 323 may determine a method of configuring an optimized UI for each virtualized guest OS based on the information analyzed through the resource monitoring module 321 and the service traffic analysis module 322.

The environmental setting factor determination module 323 may be a module which determines the environmental setting factor of a platform in order to provide an optimized UI in the virtual OS service platform, and may determine the environmental setting factor of the virtual OS service platform provided to each terminal.

In this case, the environmental information such as the hardware specification, the computing resource, and the network traffic information, etc. of the terminal may be used, and the environmental setting factor may be determined.

The screen resolution and the UI method which are able to be provided by a corresponding terminal receiving the virtual desktop service may be included as a virtual OS UI setting factor in the environmental setting factor. For example, the touch screen method, the mouse method, and the button arrangement form, etc. may be included in the virtual OS UI setting factor.

The virtual OS service platform server 300 may pre-collect and maintain a database regarding a method of structuring the UI for each virtualized guest OS and each terminal in order to determine the optimized UI of the virtual OS on a corresponding terminal.

The UI control module 324 may adaptively generate or change the UI of the virtual OS service platform for each corresponding terminal according to the environmental setting factor determined by the environmental setting factor determination module 323 through the virtual OS service engine 325.

The virtual OS service engine 325 may adaptively change the screen resolution and the UI provision method (a touch method, etc.) of the application program operating in the guest OS and the environment of the guest OS for each terminal, according to a control of the UI control module 324

Accordingly, the user of the terminal may receive a software service having an optimized UI which is adaptively changed according to the hardware specification or the network quality of the corresponding terminal.

Further, when the virtual OS service engine 325 connects to the virtual OS service platform server 300 and the terminal receiving the virtual desktop service is a mobile terminal, in the case that there is an application program developed for the mobile terminal in a desktop-based OS, the application program may be preferentially provided to the mobile terminal.

Meanwhile, a guest OS UI control module 311a may support an interface so that the user checks the optimized UI environmental setting factor determined for each terminal so as to be able to change the environmental setting factor.

The user may change a set environmental setting factor using the UI provided by the guest OS UI control module 311a in his/her own terminal receiving the virtual desktop service. Further, the UI control module 324 may change the UI of the virtual OS service platform through the virtual OS service engine 325 by reflecting the change of the environmental setting factor.

Generally, a smart phone or a tablet PC may support a computing environment for the user or access specific information using its own OS (for example, Android, iOS, etc.) and its own application program.

However, according to the embodiment of the present invention, the user may use a virtual OS connection program on his/her own OS of the terminal, connect to the virtual OS service platform server, and receive various different virtual OSs and various application programs provided by the virtual OSs. Further, the virtual OSs and the application programs may provide UIs which are adaptively changed to a corresponding terminal, and easily support the computing operation or an access of the information.

In detail, even in the case of a smart watch, the information may be provided using the smart watch's own OS and application program, and the information obtained by being connected to the smart phone of the user may be provided to the user, but the various different virtual OSs and the various application programs provided by the virtual OSs may be provided by connecting to the virtual OS service platform server. Further, the virtual OSs and the application programs may provide UIs which are adaptively changed for the smart watch, and easily support the computing operation or the access of the information.

Hereinafter, a method for providing an adaptive virtual desktop OS service according to another embodiment of the present invention will be described with reference to FIGS. 1 to 4.

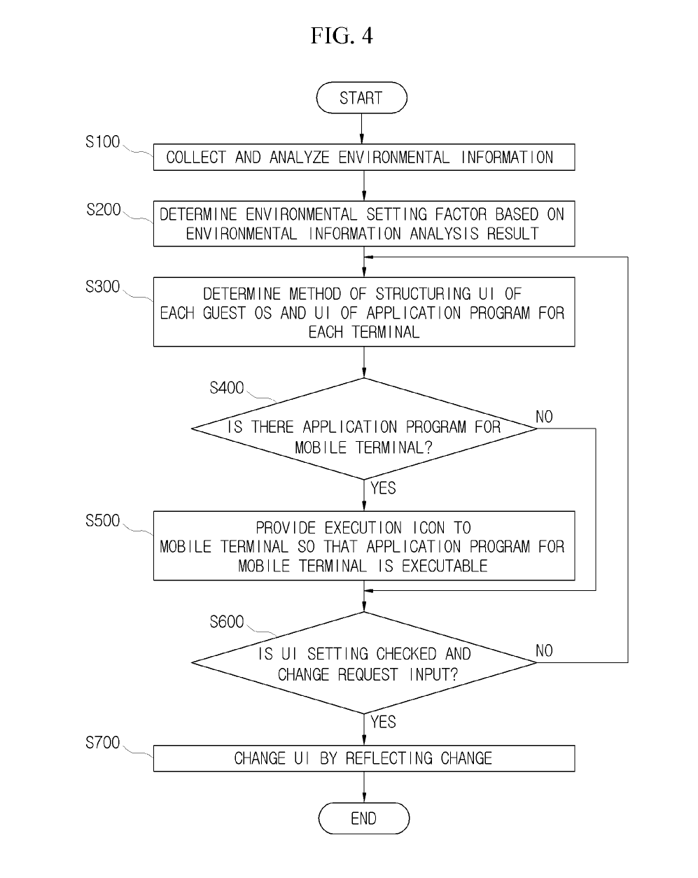

FIG. 4 is a flowchart for describing a method for providing an adaptive virtual desktop OS according to an embodiment of the present invention.

First, the virtual OS service platform server 300 may collect and analyze environmental information for generating a virtual OS service platform (S100).

Here, the environmental information may include the hardware specification, the computing resource, and the network traffic information, etc. of each of various terminals 100 connected through the network 200.

For this, the hardware resource and network monitoring agent 113 of each terminal 100 may monitor and collect the hardware specification, the computing resource, and the network traffic information of the terminal 100, and transmit the information to the virtual OS service platform server 300.

Further, the hardware resource and network monitoring agent 113 may also collect information such as the UI method which is able to be provided by a corresponding terminal, and transmit the collected information to the virtual OS service platform server 300. For example, the information may be information such as a touch screen method, a mouse method, and a button arrangement form, etc.

The resource monitoring module 321 of the virtual OS service platform server 300 may collect and analyze the hardware specification and the computing resource of the terminal provided by each terminal 100.

Further, the resource monitoring module 321 may receive and analyze the computing resource of a guest OS collected in the guest OS agent 311c through the virtual OS protocol stack 326.

Moreover, the service traffic analysis module 322 may collect and analyze the network traffic information provided from each terminal 100.

Next, the environmental setting factor determination module 323 may determine an environmental setting factor for structuring an optimized UI for each virtualized guest OS based on the information analyzed through the resource monitoring module 321 and the service traffic analysis module 322 (S200).

For this, the virtual OS service platform server 300 may pre-collect and maintain a database regarding a method of structuring a UI for each virtualized guest OS and each terminal.

The screen resolution and the UI method which is able to be provided by a corresponding terminal receiving the virtual desktop service may be included as a virtual OS UI setting factor in the environmental setting factor. For example, the touch screen method, the mouse method, and the button arrangement form, etc. may be included in the virtual OS UI setting factor.

Next, the UI control module 324 may adaptively generate or change the UI of the virtual OS service platform for each corresponding terminal according to the environmental setting factor determined in the environmental setting factor determination module 323 through the virtual OS service engine 325 (S300).

For example, the virtual OS service engine 325 may adaptively change the screen resolution and the UI provision method (the touch method, etc.) of an application program operating in the guest OS and the guest OS environment for each terminal, according to a control of the UI control module 324.

The virtual OS service platform generated and changed in operation S300 may be provided to the corresponding terminal 100 through the network 200. When the terminal which is connected to the virtual OS service platform server 300 and receives the virtual desktop service is a mobile terminal, the UI control module 324 may determine whether there is an application developed for the mobile terminal in a desktop-based OS (S400).

When there is the application developed for the mobile terminal based on the determination result of the operation S400, an execution icon may be supported so as to preferentially provide the application program to the mobile terminal (S500).

Meanwhile, the user may check the environmental setting factor determined by the environmental setting factor determination module 323 in the user's own terminal 100.

For this, the guest OS UI control module 311a may allow the user to check the optimized UI environmental setting factor determined for each terminal and change the environmental setting factor.

When the user changes the environmental setting factor set using the UI provided by the guest OS UI control module 311a in his/her own terminal 100 (S600), the UI control module 324 may change the UI of the virtual OS service platform through the virtual OS service engine 325 by reflecting the change of the environmental setting factor (S700).

According to embodiments of the present invention described above, the apparatus and method for supporting the adaptive OS and application program which can execute the application program having the high specification even when the hardware specification of the terminal is not good, and adaptively change the UI suitable for the display environment of the terminal are provided.

When connecting to the client terminal accesses the virtual desktop service in the agent of the client terminal, the virtual desktop service optimized for the environment of the client can be adaptively provided by collecting, analyzing, and controlling the information related to the hardware specification, the computing resource, and the network quality of the client terminal.

Also, the application program for the mobile terminal is developed using conventional abundant development environments based on the desktop-based OS, and the environment capable of providing the application program may be provided when the mobile terminal is connected by being executing based on the desktop-based OS.

Further, when using the virtual desktop service using the mobile terminal, the UI for the desktop OS may be changed to be suitable for a corresponding terminal such as a smart phone, etc. Accordingly, even when the user accesses the desktop-based OS, the user easily can use the desktop-based OS and the application program for desktop.

Moreover, the application program for the mobile terminal developed and executed based on the desktop-based OS can be used, and utilization of the mobile terminal can be increased.

The above description merely describes exemplary embodiments of the scope of the present invention, and it will be apparent to those skilled in the art that various modifications can be made to the above-described exemplary embodiments of the present invention without departing from the spirit or the scope of the invention. Accordingly, exemplary embodiments of the present invention are not intended to limit the scope of the invention but to describe the invention, and the scope of the present invention is not limited by the exemplary embodiments. Thus, it is intended that the present invention covers all such modifications provided they come within the scope of the appended claims and their equivalents.

What is claimed is:

1. A method for providing an adaptive virtual desktop operating system (OS) service in a virtual OS service platform server providing a virtual OS service platform service suitable for a terminal connected through a network, the method comprising:
collecting and analyzing environmental information including at least one among hardware specification information, computing resource information, and network traffic information of the terminal, and computing resource information of a guest OS operated in a virtual machine generated by the virtual OS service platform server;
determining an environmental setting factor for structuring a user interface (UI) suitable for the terminal with respect to the virtual machine based on the analyzed result; and
adaptively generating or changing a UI of the virtual OS service platform provided to the terminal based on the determined environmental setting factor.

2. The method for providing the adaptive virtual desktop OS service of claim 1, wherein the collecting and analyzing of the environmental information comprises:
receiving at least one among the hardware specification information, the computing resource information, and the network traffic information from the terminal.

3. The method for providing the adaptive virtual desktop OS service of claim 2, wherein the collecting and analyzing of the environmental information, the determining of the environmental setting factor, and the adaptively generating or changing of the UI comprise performed in the virtualization desktop platform layer included in the virtual OS service platform server.

4. The method for providing the adaptive virtual desktop OS service of claim 2, wherein the collecting and analyzing of the environmental information, and the determining of the environmental setting factor comprise performed in the virtualization desktop platform layer included in the virtual OS service platform server,
wherein the adaptively generating or changing of the UI comprises adaptively generating or changing the UI of a virtual OS, by each of the virtual machine, based on the determined environmental setting factor which transmitted in the virtualization desktop platform layer to any one among the plurality of virtual machines.

5. The method for providing the adaptive virtual desktop OS service of claim 2, wherein the collecting and analyzing of the environmental information comprises:
collecting the environmental information from the terminal through the network;
transmitting the collected environmental information to any one among the plurality of virtual machines; and
analyzing of the environmental information by the virtual machines receiving the environmental information,
wherein the determining of the environmental setting factor comprises determining the environmental setting factor by the virtual machines receiving the environmental information based on the analyzed result.

6. The method for providing the adaptive virtual desktop OS service of claim 1, wherein the determining of the environmental setting factor comprises:
determining a virtual OS UI setting factor including a screen resolution and a UI method which is able to be provided by the terminal.

7. The method for providing the adaptive virtual desktop OS service of claim 1, wherein the determining of the environmental setting factor comprises:
determining the environmental setting factor for each guest OS and each terminal virtualized using a database regarding a method of structuring the UI for each virtualized guest OS and each terminal.

8. The method for providing the adaptive virtual desktop OS service of claim 1, wherein the adaptively generating or changing of the UI comprises:
adaptively changing a screen resolution and a UI provision method of an application program operating in a guest OS and an environment of the guest OS for each terminal.

9. The method for providing the adaptive virtual desktop OS service of claim 1, further comprising:
when the terminal which is connected to the virtual OS service platform server and receives an adaptive virtual OS service platform service is a mobile terminal, preferentially providing an application program developed for the mobile terminal in a desktop-based OS to the mobile terminal.

10. A virtual operating system (OS) service platform server providing a virtual OS service platform service suitable for a terminal connected through a network, comprising:
a communication module configured to collect environmental information including at least one among hardware specification information and computing resource information of the terminal, computing resource information of a guest OS operated in a virtual machine, and network traffic information of the terminal, through the network; and
a control module configured to analyze the environmental information and the network traffic information, determine an environmental setting factor for structuring a user interface (UI) suitable for the terminal with respect to the virtual machine based on the analyzed result, and adaptively generate or change a UI of a virtual OS service platform provided to the terminal based on the determined environmental setting factor.

11. The virtual OS service platform server of claim 10, wherein the communication module receiving at least one among the hardware specification information, the computing resource information, and the network traffic information from the terminal.

12. The virtual OS service platform server of claim 11, further comprising virtualization desktop platform layer,
wherein the communication module collect the environmental information of the terminal in the virtualization desktop platform layer, and
the control module analyze the environmental information, determine the environmental setting factor based on the analyzed result, and adaptively generate or change the UI of a virtual OS service platform based on the determined environmental setting factor in the virtualization desktop platform layer.

13. The virtual OS service platform server of claim 11, further comprising virtualization desktop platform layer,
wherein the communication module collect the environmental information of the terminal in the virtualization desktop platform layer, and
the control module analyze the environmental information, determine the environmental setting factor based on the analyzed result, and transmitting the environmental setting factor to any one among the plurality of virtual machines in the virtualization desktop platform layer,
wherein the virtual machine adaptively generate or change the UI of a virtual OS service platform based on the determined environmental setting factor.

14. The virtual OS service platform server of claim 11, wherein the communication module collect the environmental information from the terminal through the network, and transmit the collected environmental information to any one among the plurality of virtual machines,
wherein the virtual machines receiving the environmental information analyzing of the environmental information, and determine the environmental setting factor based on the analyzed result.

15. The virtual OS service platform server of claim 10, wherein the virtual OS service platform server determines the environmental setting factor for each guest OS and each terminal virtualized using a database regarding a method of structuring the UI for each virtualized guest OS or each terminal.

16. The virtual OS service platform server of claim 10, wherein the control module adaptively changes a screen resolution and a UI provision method of an application program operating in a guest OS and an environment of the guest OS for each terminal.

17. The virtual OS service platform server of claim 10, further comprising:
a guest OS UI control module configured to support an interface so that a user checks a UI environmental setting factor determined for each terminal and changes the UI environmental setting factor.
